(19) United States
(12) Patent Application Publication
(10) Pub. No.: US 2020/0138551 A1
(43) Pub. Date: May 7, 2020

(54) DENTAL-ABUTMENT DESIGN SYSTEM AND METHOD

(71) Applicant: EVOLLUTION IP HOLDINGS, INC., Birmingham, AL (US)

(72) Inventors: Jeffery Todd STRONG, Vestavia, AL (US); Jeremy Todd STRONG, Vestavia, AL (US); Joshua Xiaohua HU, Vestavia, AL (US); Jerry Jingyuan HU, Vestavia, AL (US)

(73) Assignee: EVOLLUTION IP HOLDINGS, INC., Birmingham, AL (US)

(21) Appl. No.: 16/427,671

(22) Filed: May 31, 2019

Related U.S. Application Data
(60) Provisional application No. 62/756,192, filed on Nov. 6, 2018.

(51) Int. Cl. A61C 8/00; A61C 13/34

(52) U.S. Cl. CPC A61C 8/005; A61C 13/0004; A61C 13/34; A61C 8/0037

(57) ABSTRACT

A semi-custom dental abutment is provided by capturing objective oral geometry of a patient's mouth without the need to use 3D scanning equipment, designing the semi-custom dental abutment based on the captured data and using abutment design software that has menus of discrete incremented design options such as rotational position, subgingival shape, and overall abutment dimensions, and outputting data representing the design for further processing to manufacture the semi-custom dental abutment. Aspects of the invention include the overall semi-custom dental design method as well as the semi-custom dental abutment design software used in the method.

### CROSS-REFERENCE TO RELATED APPLICATION

This application claims the priority benefit of U.S. Provisional Patent Application Ser. No. 62/756,192 filed Nov. 6, 2018, the entirety of which is hereby incorporated herein by reference for all purposes.

### TECHNICAL FIELD

The present invention relates generally to the field of restorative implant dentistry, and more particularly to systems and methods of designing and manufacturing dental abutments.

### BACKGROUND

Dental abutments are used in restorative implant dentistry to join dental prostheses (artificial teeth) to dental implants (artificial teeth roots). Typically, dental abutments are designed and manufactured by using 3D intraoral scanning systems and dental CAD software that provide a high degree of customization for optimized abutment design for the specific patient and that generate a customized/optimized digital model that enables the use of CAM systems to manufacture the custom dental abutment. Advantageously, these CAD systems provide for toggling through a range of virtually unlimited positions (via “handles” that be clicked on and moved to manipulate the digital design into any unique desired shape, often amorphic) to produce an optimized abutment design that is truly unique to the specific oral anatomy of the specific patient. However, the 3D intraoral scanning systems tend to be expensive, and the dental CAD software tends to be very expensive and difficult to use. As a result of this, such conventional custom/optimum abutment design capabilities tend to be out of the reach of many dental professionals.

Accordingly, it can be seen that needs exist for dental abutment design systems and methods that can be used by more dental professionals. It is to the provision of solutions meeting these and other needs that the present invention is primarily directed.

### SUMMARY

Generally, the present invention relates to systems and methods of designing and manufacturing semi-custom dental abutments. In one aspect, an overall design method includes capturing objective oral geometry of a patient's mouth without the need of using 3D scanning equipment, designing a digital model of a semi-custom dental abutment based on the captured data and by using abutment design software that has menus of a small/minimal number of discrete incremented design options such as rotational position, subgingival shape, and overall abutment dimensions, and outputting data representing the digital model design for further processing to manufacture the semi-custom dental abutment.

In another aspect, the invention relates to a method of using a CAM system to manufacture a semi-custom dental abutment based on the data representing the digital model design. And in another aspect, the invention relates to semi-custom dental abutment design software used in the overall dental restoration method.

The specific techniques and structures employed to improve over the drawbacks of the prior systems and accomplish the advantages described herein will become apparent from the following detailed description of example embodiments and the appended drawings and claims.

### BRIEF DESCRIPTION OF THE DRAWINGS

FIG. 1 is a perspective view of an overall semi-custom abutment design and manufacture process according to an example embodiment of the present invention.

FIG. 2 is a top view of a portion of a dental arch showing an implant, a pocket margin surrounding the implant, and pocket margin widths being manually measured according to the measurement step of FIG. 1.

FIG. 3 is a side view of the dental arch portion of FIG. 2 showing a pocket margin height/depth being manually measured.

FIG. 4 shows the dental arch portion of FIG. 2 with an implant timing angle being manually measured.

FIG. 5 is a screen display of semi-custom abutment design software being used to select an abutment topcap base shape according to a setup step of FIG. 1, with an abutment base type for a molar tooth selected in the left window and displayed in the right window.

FIG. 6 is a screen display of the right window of FIG. 5 except showing an abutment base type for a bicuspid tooth selection.

FIG. 7 is a screen display of the right window of FIG. 5 except showing an abutment base type for an incisor tooth selection.

FIG. 8 is a screen display of the right window of FIG. 5 except showing a healing abutment base type for a corresponding type selection.

FIG. 9 is a screen display of the right window of FIG. 5 except showing a titanium abutment base type for a corresponding type selection.

FIG. 10 is a screen display of the semi-custom abutment design software being used to select an abutment emergence base shape according to the emergence-selection sub-process of the discrete-input step of FIG. 1, with a timing angle selected in the left window and displayed in the right window.

FIG. 11 is a screen display of the right window of FIG. 10 except showing a straight emergence base shape for a corresponding subgingival shape selection.

FIG. 12 is a screen display of the right window of FIG. 10 except showing a concave emergence base shape for a corresponding subgingival shape selection.

FIG. 13 is a screen display of the right window of FIG. 10 except showing a convex emergence base shape for a corresponding subgingival shape selection.

FIG. 14 is a screen display of the semi-custom abutment design software being used to input discrete values to semi-customize the abutment emergence base shape according to the margin-design sub-process of the discrete-input step of FIG. 1, with the input features set for the emergence base shape in the left window and with the resulting emergence base shape displayed in the right window.

FIG. 15 shows the screen display of FIG. 14 with the input features showing selections for the semi-custom emergence shape in the left window and with the resulting semi-custom emergence shape displayed in the right window.

FIG. 16 is a screen display of the semi-custom abutment design software being used to input discrete values to semi-customize the abutment topcap base shape according to the topcap-design sub-process of the discrete-input step of FIG. 1, with the input features showing selections for the semi-custom topcap shoulder width in the left window and with the resulting semi-custom topcap displayed in the right window.

FIG. 17 is a screen display of the right window of FIG. 16 except showing a semi-custom topcap height resulting from a corresponding selection.

FIG. 18 is a screen display of the right window of FIG. 16 except showing a semi-custom topcap buccal-lingual angle resulting from a corresponding selection.

FIG. 19 is a screen display of the right window of FIG. 16 except showing a semi-custom topcap mesial-distal angle resulting from a corresponding selection.

FIG. 20 is a right-window screen display of the semi-custom abutment design software being used to confirm a resulting digital abutment design according to the visualization step of FIG. 1, showing a coordinate system for reference for the digital abutment design.

FIG. 21 shows the screen display of FIG. 20 except with the digital abutment design reoriented in 3D space during a visual design check.

FIG. 22 is a right-window screen display of the semi-custom abutment design software being used to display a wireframe-view STL file that was created from the digital abutment design and that can be output according to the output step of FIG. 1 to perform the CAM steps of FIG. 1.

FIG. 23 is a perspective view of the dental arch of FIG. 1, showing the physical semi-custom abutment mounted in place (to and over the underlaying implant) and ready for the prosthesis to be mounted to it.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Generally, an abutment design software system is provided that includes only a small/minimized number of design options such that the produced abutment design is not customized in the sense that is optimized for the specific patient, but rather such that the abutment design is “semi-customized” to be a “good-enough” or “close-enough” approximation of an optimized design to provide only a functionally acceptable (i.e., for fit, comfort, and performance) degree of customization (and not an optimized one) of the resulting physical abutment. This is done by using only a limited/small number design inputs, with each having only a limited/small number of options, with these limited inputs and options limited to discrete increments, with these limited inputs and options readily obtainable by manual measurements (e.g., with a tool and/or by visual estimation), and with these limited inputs and options common to many patients and thus not actually unique to the patient. As such, the term “semi-custom” means limited customization and is thus substantially different from fully customized (i.e., optimized). As a result, the semi-custom abutment design software is less costly and also is easier to use than conventional dental CAD software. Also, the semi-custom abutment design software system requires less in the way of oral geometry data inputs (relative to conventional dental CAD software), so 3D scanners are not needed to obtain the inputs needed to design the semi-custom abutments. At the same time, the semi-custom abutment design software can still be used to generate a data file of a digital abutment model that can be used by conventional CAM systems to manufacture the semi-custom abutment. Because CAM systems can be used that provide a high degree of precision in manufacturing complex shapes, the resulting physical abutment includes only functionally acceptable inaccuracies (relative to an optimized design) because inaccuracies resulting from the approximations in the semi-customized design are not magnified by allowable tolerances in the manufacturing process.

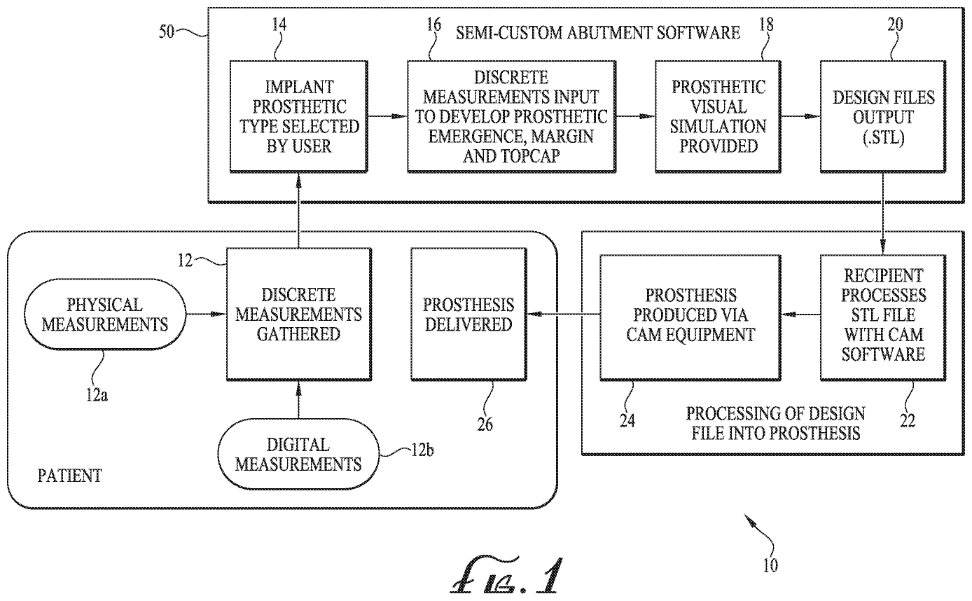

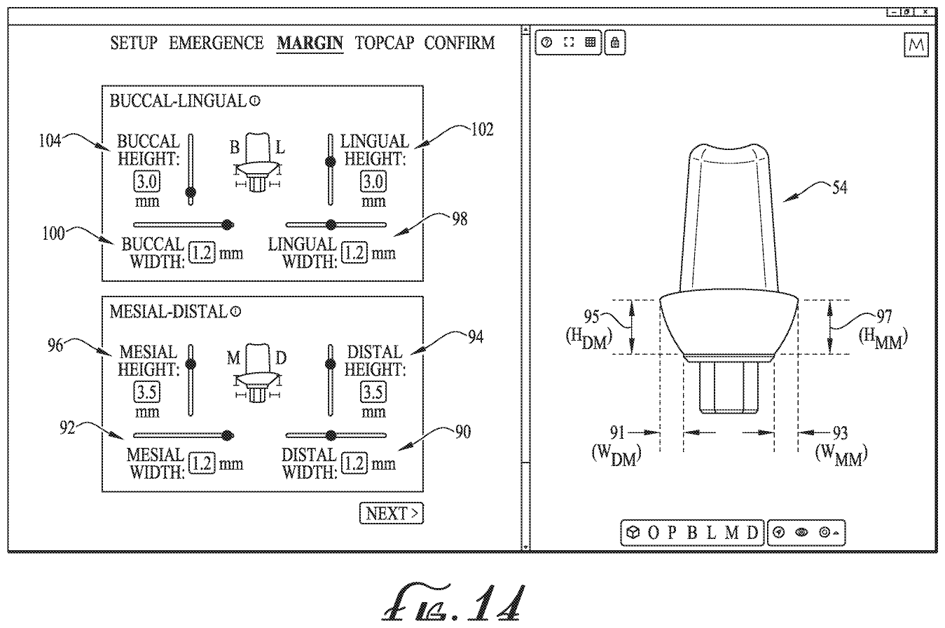

With reference now to the drawing figures, wherein like reference numbers represent corresponding parts throughout the several views, FIGS. 1-23 show an overall dental restoration method 10 of designing and manufacturing a semi-custom abutment 30 by using abutment design software 50 according to an example embodiment of the invention.

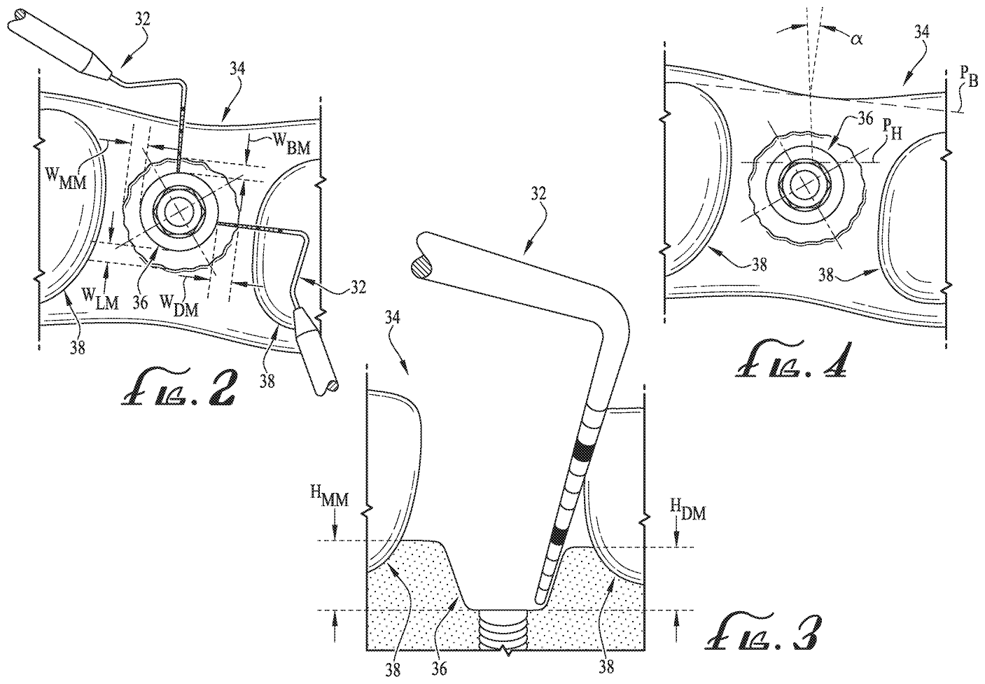

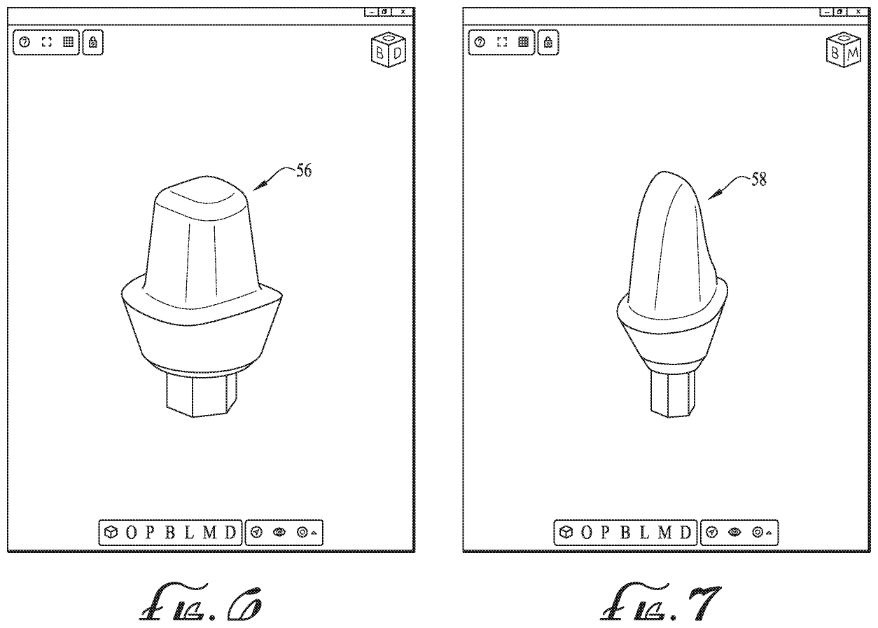

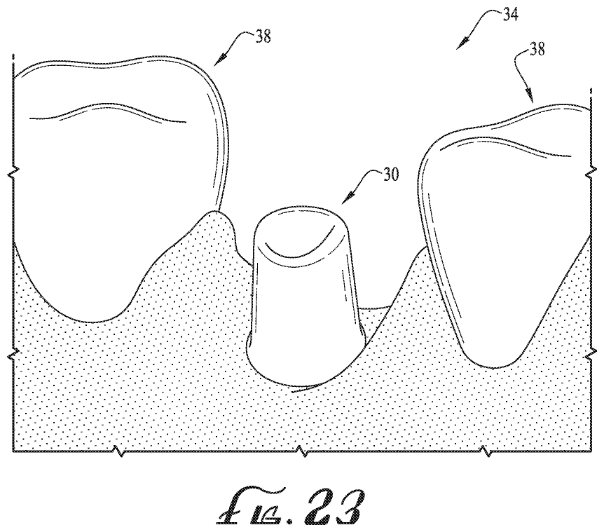

FIGS. 1-23 show an overall dental restoration method 10 of designing and manufacturing a semi-custom abutment 30 by using abutment design software 50 according to an example embodiment of the invention. FIGS. 2-4 and 23 show steps of the method 10 performed on the patient, FIGS. 5-21 show steps of the method 10 performed using the abutment design software 50, and FIG. 22 show steps of the method 10 performed using a CAM process.

Referring to FIGS. 1-4, step 12 of the method 10 includes capturing oral geometry of the patient for inputting into the abutment design software 50. Only minimal discrete oral geometry data is required for use of the abutment design software 50, and so 3D scanning equipment is not needed. Instead, as indicated at 12a, the oral geometry can be captured manually as basic discrete measurements taken by the dental professional. These manual measurements can be taken using conventional hand-held dental metrology tools such as a periodontal probe 32, a ruler/protractor-like dental device, or other dental measuring tools known in the art. These measurements can be obtained in a direct manner (directly from the patient's mouth 34) or an indirect manner (from a stone casting or other physical model of the patient's mouth 34). For some dental professionals, some or all of these manual measurements can be obtained by a visual estimation, with or without using any tools, which is a skill commonly used by dentists when evaluating spatial requirements of an oral surgical site.

Although 3D scanners are not required for capturing the oral geometry data at step 12, they can be used if desired. As such, the basic discrete measurements for inputting into the abutment design software 50 can be obtained by a dental professional using a conventional 3D scanner, as indicated at 12b. The use of such conventional 3D scanning equipment is well known in the art and so for brevity additional details are not described herein.

As shown in FIGS. 2-4, the manual measurements taken are of the oral area surrounding the treatment site where a dental implant 36 has been implanted. These measurements include the sulcus/pocket margin height/depth and width on all four “sides” (buccal, lingual, mesial, and distal) of the implant 36. For example, FIGS. 2-3 show a periodontal probe 32 used by the dental professional to take these manual measurements of the patient's mouth 34. FIG. 2 shows the periodontal probe 32 used to capture linear measurements of the buccal margin width W_{BM} and the distal margin width W_{DM} for a patient having an existing implant 36 between two existing teeth or prostheses 38 (if there's an existing prosthesis/crown, it'd first be removed). It will be understood that the lingual margin width W_{LM} and the mesial margin width W_{MM} are on the opposite respective sides of the implant 36 and can be measured in the same way. Also, FIG. 3 shows the periodontal probe 32 used to capture a linear measurement of the distal margin height H_{MM} (i.e., sulcus/pocket depth) for a patient having an existing implant 36 between two existing teeth or prostheses 38. It will be understood that the mesial margin height H_{MM} is measured on the opposite side of the implant 36 and can be measured in the same way, and the lingual and buccal margin heights (not shown) are measured on the other two sides of the implant 36 and can be measured in the same way. In other embodiments, fewer margin widths and heights are measured for inputting into the semi-custom abutment software 50, for example only one or two of the margin width measurements and only one or two of the margin height measurements.

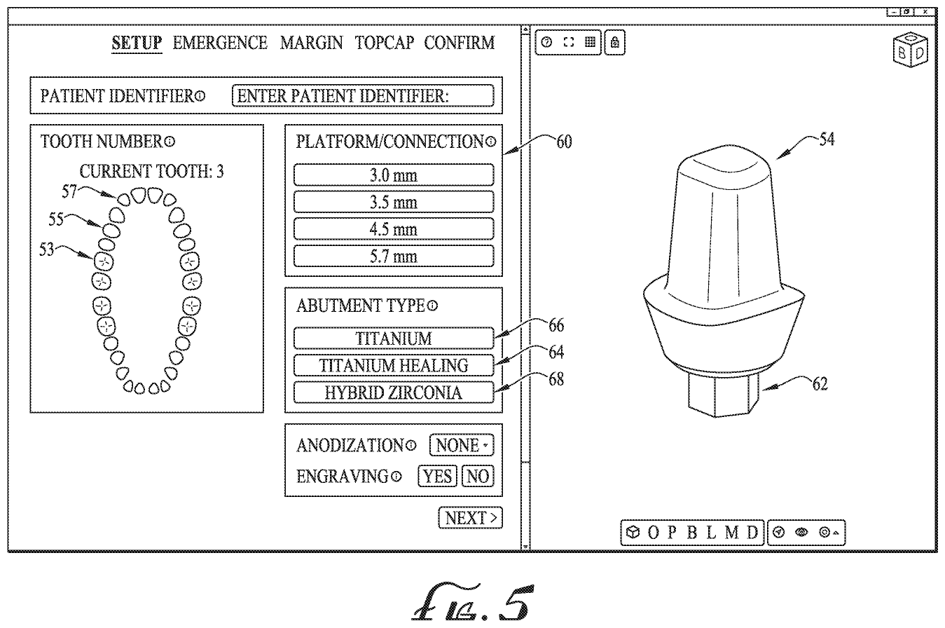

In addition, in typical embodiments the manual measurements taken include an offset (timing) angle defining the angular orientation (about the implant longitudinal axis) of a feature of the implant 36 for inputting into the semi-custom abutment software 50 for determining the proper angular orientation of the abutment so that the resulting prosthesis is correctly aligned in the dental arch. For example, FIG. 4 shows the offset timing angle α between the hex plane P_{H} of a hex-nut implant 36 and the buccal plane P_{B} of the patient's mouth for a patient having an existing implant 36 between two existing teeth or prostheses 38. The timing angle α can be determined for example by using a periodontal probe as a straightedge from which the timing angle can be visually estimated. The offset angle α in the depicted embodiment is based on the use of an implant 36 having a hex-shaped interface (for engagement by a mating tool for tightening/installing and untightening/removing), and in other embodiments the offset angle is based on another feature (e.g., another plane defined by another part of the implant) for determining the proper angular orientation of the abutment so that the resulting prosthesis is correctly aligned in the dental arch.

Alternatively, the margin widths, the margin heights, and the offset angle α can be manually measured by using a dental ruler/protractor tool, by using another dental tool for taking linear and/or angular measurements, and/or by visual estimation by the dental professional. Also, one of the margin widths can be measured using a dental tool and the other three margin widths estimated based on visual inspection if they are slightly smaller, slightly larger, or substantially the same, and/or one of the margin heights can be measured using a dental tool and the other three margin heights estimated based on visual inspection if they are slightly smaller, slightly larger, or substantially the same. As such, the term “manual measurements,” as used herein in the context of the inexact design of a semi-custom abutment, includes visual estimations, whether made with the aid of a reference tool (e.g., the periodontal probe) or unassisted with only the naked eye.

Referring back to FIG. 1, steps 14-20 of the method 10 are performed using the abutment design software 50, as shown with additional reference to the example screen displays of FIGS. 5-21. In the depicted embodiment, the software 50 functions to display two windows, with one window (e.g., the left one) including the few discrete inputs, and with the other window (e.g., the right one) including the digital abutment 54 as semi-customized based on those inputs. For convenience, some of the figures include only the left or the right window. In other embodiments, other screen layouts can be used, for example upper and lower split-screen displays, or a toggle feature can be provided for switching between full-screen views.

Generally described, the design method implemented by the abutment design software 50 includes a “setup” step in which a base abutment top portion (the “topcap”) is selected based on the tooth location, an “emergence” step in which a base abutment bottom portion (the “emergence”) is selected based on the clinician's expertise (e.g., preference and/or experience), a “margin” step in which measurements from step 12 are input to semi-customize the abutment bottom portion/emergence, and a “topcap” step in which dimensions (e.g., width and height) and tilt angles (e.g., in two perpendicular planes) are input based on the clinician's expertise to semi-customize the abutment top portion/topcap. In the depicted embodiment, four buttons are screen-displayed for each of these four steps (see, e.g., FIG. 5), which are proceeded through by clicking on the respective buttons. At each of these steps, one or more interface features are displayed that correspond to the dimensional options for adjusting the geometry of the emergence and/or topcap of the abutment, and upon user entry of selections (e.g., measurements or shapes/types) via the interface features, a correspondingly adjusted model of the abutment is displayed. Additional conventional features can be included in the software, such as for entering and storing patent identification information.

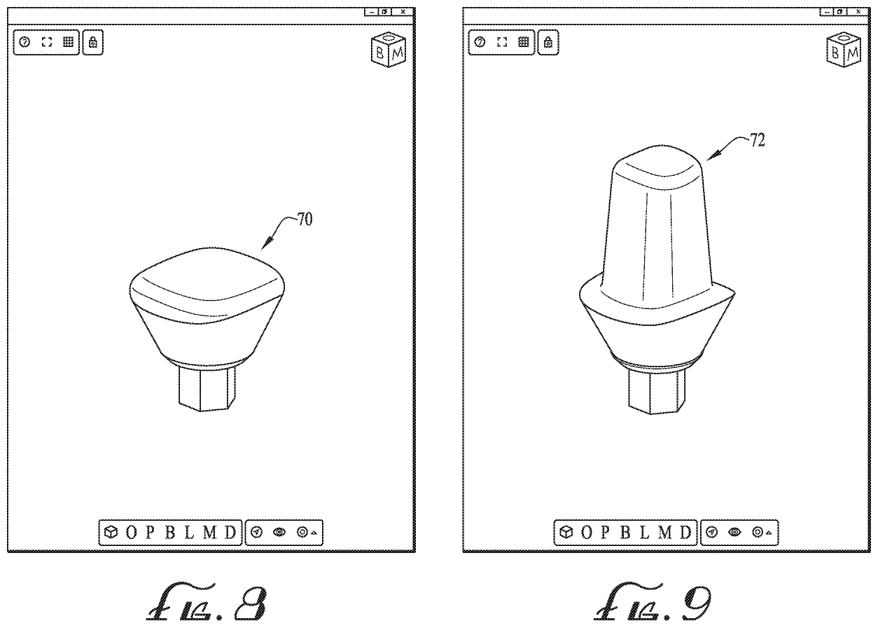

At step 14 of the method, a prosthetic setup process is performed, as shown with reference to the screen displays of FIGS. 5-9. The different types of the teeth of the mouth have a basic morphology that tends to drive design of the underlaying abutments. So the user is presented with an option for selecting a tooth, for example the dental arch shown in FIG. 5 (left window). When the user enters a selection of a tooth, for example by clicking on it, a digital model of an uncustomized/generic “base” (i.e., virtual blank or slug) abutment is displayed, for example as shown in FIG. 5 (right window) and FIGS. 6-7. These base abutments can include squared designs 54 for posterior teeth (molars) 53 (FIG. 5), narrow/ovoid designs 56 for the intermediate teeth (bicuspids) 55 (FIG. 5, left window, and FIG. 6), and triangular/flat designs 58 for anterior teeth (incisors) 57 (FIG. 5, left window, and FIG. 7).

As part of this setup process 14, the user is also presented with an option for selecting an abutment connection size (i.e., platform/connection), for example the connection size buttons 60 shown in FIG. 5 (left window). When the user enters a selection of an abutment connection size, for example by clicking on the corresponding connection size button, the connection 62 of the base or generic abutment displayed in the right window assumes this size, as shown in FIG. 5 (right window). The connection shapes and sizes shown are for typical embodiments that include hex-connections, but as noted above other implants can be used with other connections, and so the software 50 can be programmed for designing other abutment connection shapes and sizes. As such, the software can be programmed to present the user an option to select an abutment provider/manufacturer, and as appropriate a menu of abutment products offered by each provider, and upon the user entering a selection the corresponding connection shape is displayed.

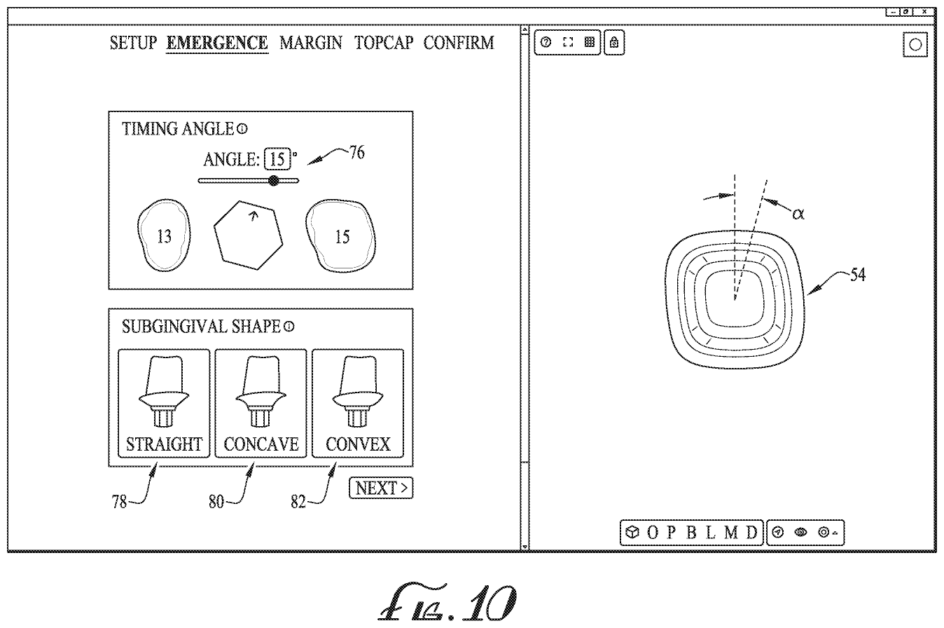

And as another part of this setup process 14, the user can also be presented with an option for selecting an abutment type, for example the abutment type buttons 64-68 shown in FIG. 5 (left window). When the user enters a selection of an abutment type, for example by clicking on the corresponding button, the corresponding abutment type is displayed as the base or generic abutment in the right window. Thus, clicking on the “Titanium Healing” button 64 displays a base or generic healing-type abutment 70 made of titanium (instead of the squared, narrow/ovoid, triangular/flat, or other abutment design selected above), as shown in FIG. 5 (left window) and FIG. 8. Healing abutments are designed for use during a healing period after implant installation. Similarly, clicking on the “Titanium” button 66 displays a base or generic abutment 72 made of titanium (e.g., the squared design of FIG. 5 (right window) selected in titanium material), as shown in FIG. 5 (left window) and FIG. 9. And clicking on the “Hybrid Zirconia” button 68 displays the same shape/design base or generic abutment except made of a hybrid zirconia material (not shown). Additional options can be presented/displayed for selection and incorporation in the digital model displayed, for example “anodization” and/or “engraving” for the titanium selections 64 and 66.

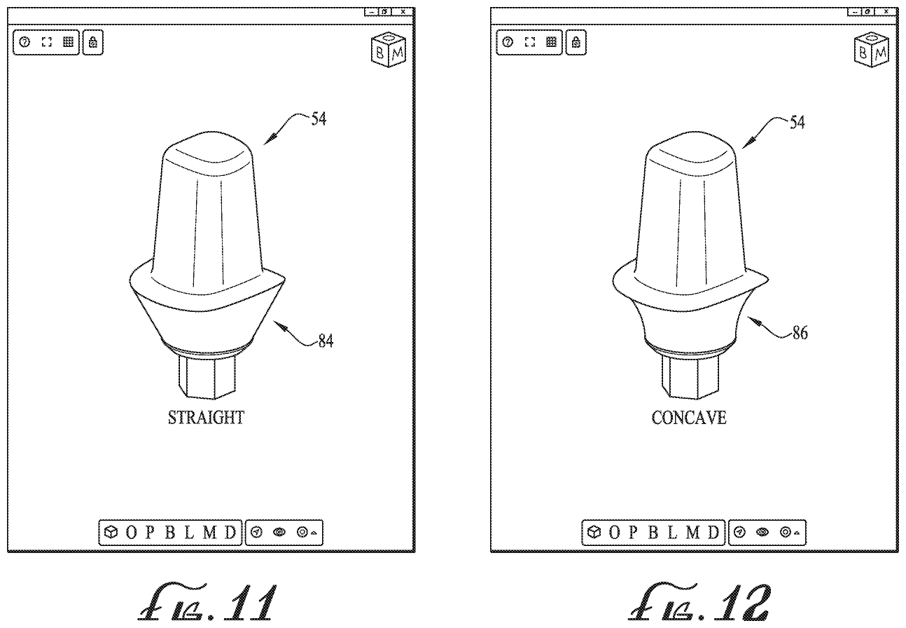

At step 16 of the method 10, the basic measurements from step 12 are input into the abutment design software 50 for semi-customization of the base abutment design 54, for example in sub-processes for designing the abutment emergence, margin, and topcap, as shown with reference to the screen displays of FIGS. 10-19.

The software can provide for inputting the offset (timing) angle α at any time in the design process, for example it can be included in the emergence design sub-process of step 16, as depicted, or alternatively in the setup step 14. As such, the user can be presented with an option for entering the offset (timing) angle α measured at step 12, for example as a sliding button 76 as shown in FIG. 10 (left window), and the base abutment design displayed 54 is then semi-customized to be oriented at that angle as shown in FIG. 10 (right window). Important in the design of prosthetics is the position of implant anti-rotation features. In the depicted embodiment, the implant 36 is screw-form with an internal (female) hex connection, and the abutment 30 of the prosthesis has an externally mating (male) hex connection. Thus, for the prosthetic design to fit correctly in the mouth, the hex position (or timing/angle) of the implant in the mouth must be identified. In this manual workflow, the offset angle α can be determined as a function of a line perpendicular to the buccal aspect of the mouth, or perpendicular to a tangent of the dental arch centerline (mandible or maxilla), by manual measurement as described in step 12 above. Alternatively, the software can provide other input features for setting the timing or offset angle α, for example by screen-displaying a data input field for discrete number input, such as values from 0 to 30 degrees (for a hex connection) in predefined increments (e.g., 1.0, 2.0, or 5.0 degrees).

As part of the emergence design sub-process of step 16, the user can be presented with an option for entering a subgingival “emergence” base (generic) shape from a menu of only a few basic options in keeping with the semi-customization aspect of the software. The base subgingival shape of the abutment design is selected by the dental professional based on the desired end result and the dental professional's expertise (e.g., preference and/or experience). The emergence is the lower portion of the abutment 54 below the topcap, that is, it extends between the connection end of the abutment 54 (closest to the implant connection) and the margin (edge/shoulder) of the abutment 54 where the topcap begins.

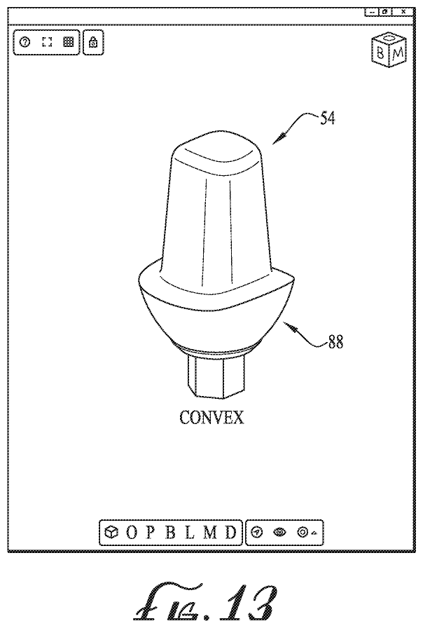

In the depicted embodiment, buttons are presented for “straight” 78, “concave” 80, and “convex” 82 emergencies, as shown in FIG. 10 (left window), and upon a user clicking on one of these buttons, the corresponding base subgingival shape 84, 86, and 88 is semi-customized into the displayed abutment design 54, as shown in FIGS. 11-13, respectively. A “straight” emergence 84 is defined as having a substantially straight/conical profile. A “concave” emergence 86 is defined by a bowed-in or recessed surface, and a “convex” emergence 88 is the opposite, a bowed-out or bulged surface. Additional emergence shapes, including varying degrees and/or combination of those depicted, can be provided as options in some embodiments. And in alternative embodiments, the software provides screen-displayed features for semi-customizing the emergence shape, for example slide bars or a data input fields for entering widths at the two ends and at the vertical mid-point, or for entering a radius, for concave and convex shapes.

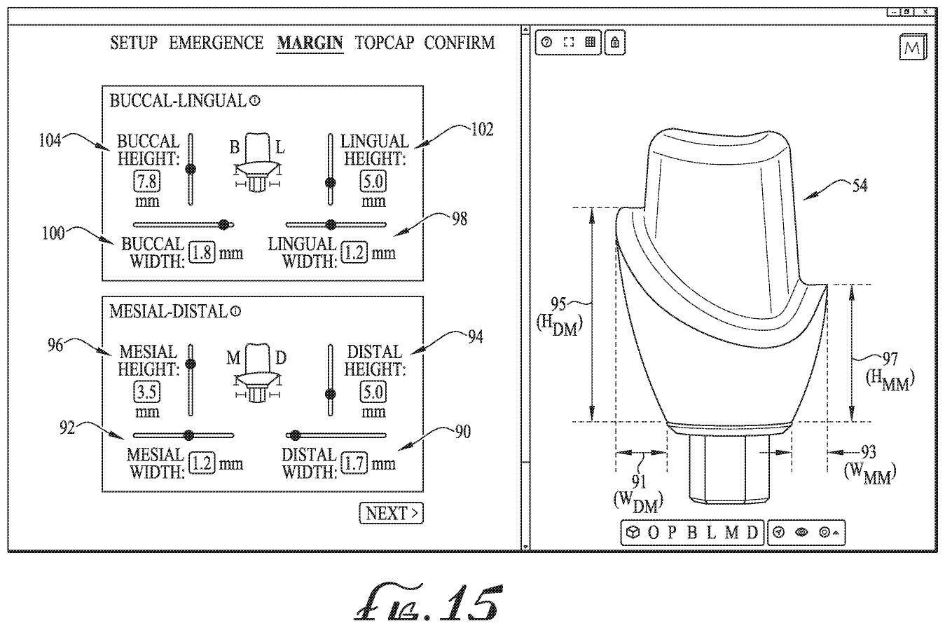

In the margin design sub-process of step 16, the user can be presented with options for entering some or all of the pocket “margin” widths and heights relative to the implant 36 as measured in step 12 above to semi-customize the emergence of the digital abutment 54. Buccal-lingual width and height refer to the pocket margin dimension in the cheek-to-tongue plane for a given tooth position, and mesial-distal width and height are perpendicular to that, as shown and described above with respect to step 12. For example, the user can be presented with sliding buttons for inputting the margin widths and heights (in predefined increments, e.g., 0.1, 0.2, or 0.5 mm) on all four sides (buccal, lingual, mesial, and distal) of the implant 36, thereby providing only a few basic options in keeping with the semi-customization aspect of the software 50, as shown in FIGS. 14-15. In alternative embodiments, the software provides options for entering only one, two, or three of the pocket margin widths, and only one, two, or three of the pocket margin heights (depths), for minimal customization of the emergence by inputting a minimal number of representative or averaged dimensions. For example, in some embodiments only one of the margin width measurements and only one of the margin height measurements are entered, with those values based on an average, or a minimum or a maximum, of the measurements taken. Also in alternative embodiments, the software provides other screen-displayed features for entering the dimensions, for example a data input field can be provided for entering the individual dimensions, or a menu of predefined dimensions or ranges can be provided to select from (e.g., “narrow,” “medium,” and “wide” that correspond to predetermined width ranges, and/or “short,” “medium,” and “tall” that correspond to predetermined height ranges).

As depicted, a button 90 corresponding to the width of the distal margin (W_{DM} from FIG. 2) can be adjusted (for example, from 1.2 mm to 1.7 mm, see FIGS. 14-15, left windows) to produce a customization of the digital abutment 54 displayed by correspondingly adjusting the distal margin width 91 (see FIGS. 14-15, right windows). Similarly, a button 92 corresponding to the width of the mesial margin (W_{MM} from FIG. 2) can be left unchanged (for example, at 1.2 mm, see FIGS. 14-15, left windows) to produce a customization of the digital abutment 54 displayed by leaving unchanged the mesial margin width 93 (see FIGS. 14-15, right windows). Along the same lines, a button 94 corresponding to the height of the distal margin (H_{DM} from FIG. 3) can be adjusted (for example, from 3.5 mm to 5.0 mm, see FIGS. 14-15, left windows) to produce a customization of the digital abutment 54 displayed by correspondingly adjusting the distal margin height 95 (see FIGS. 14-15, right windows). Further similarly, a button 96 corresponding to the height of the mesial margin (H_{MM} from FIG. 3) can be left unchanged (for example, at 3.5 mm, see FIGS. 14-15, left windows) to produce a customization of the digital abutment 54 displayed by leaving unchanged the mesial margin height 97 (see FIGS. 14-15, right windows). Additional buttons 98, 100, 102, and 104 are provided for adjusting the lingual margin width (W_{LM} from FIG. 2), the buccal margin width (W_{BM} from FIG. 2), and the lingual and buccal margin heights (see generally FIG. 3), respectively.

After this margin sub-process is completed, the previously symmetric base abutment 54 of FIG. 14 is now partially customized to the more patient-specific abutment 54 of FIG. 15. However, this has been done simply and only by entering discrete measurements into the software to achieve the desired customization, thereby incrementally modifying the height and width dimensions, and thus the relative proportions, of the digital abutment 54. As such, the semi-customized emergence design of the abutment 54 is done purely by numerical input of eight pocket margin measurements (in keeping with the semi-customization aspect of the software 50), without any visual relation to neighboring anatomy, as in other more-complex systems.

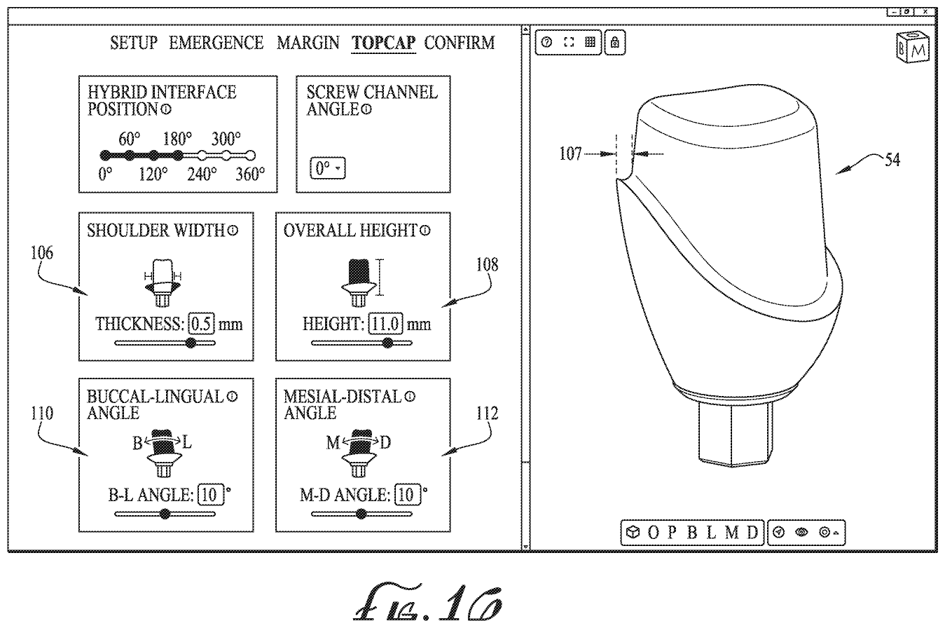

In some embodiments, the software 50 can provide for customizing a hybrid interface position of the abutment (see, e.g., FIG. 16). Specific to the hybrid zirconia restorations is positioning of the “titanium base”—an implant-interfacing insert to which the zirconia is typically bonded before attachment to the implant. Because the connections are “timed” at a predetermined angle, there is the opportunity to rotate the assymetrical abutment bottom portion to an ideal position as it relates to several design considerations. With the hex connection depicted in the various drawings, there are six possible indexed positions available.

In addition, some embodiments of the software 50 can provide for customizing an angle of a screw channel formed in the abutment (see, e.g., FIG. 16) for receiving a dental screw for fastening the abutment to the implant. While not necessarily associated with the topcap, the software can provide for entering this adjustment here or elsewhere in the design process. In some embodiments the software displays a preview of the screw channel angle and in others is does not. The screw channel angle is sometimes important to be able to design a prosthesis that can be delivered with a screw access that does not interrupt the biting (incisal) edge of a prosthesis/crown, with functional and aesthetic ramifications.

In the topcap design sub-process of step 16, the user can be presented with options for entering some or all of the “topcap” design parameters. Generally speaking, the “topcap” is the top portion of the abutment above the bottom portion (i.e., the emergence) and thus above the abutment margin (i.e., the line) separating (i.e., delineating) the topcap and the emergence. The topcap design parameters can be selected based on the clinician's expertise (e.g., preference and/or experience). For example, the user can be presented with sliding buttons for inputting the width of the abutment shoulder (defining the lateral offset of the abutment margin between the topcap and the emergence) and the overall height of the overall abutment (the topcap and the emergence), as well as the topcap axial angles (relative to the axis defined by the connection) in two perpendicular planes, thereby providing only a few basic options in keeping with the semi-customization aspect of the software 50, as shown in FIGS. 16-19. The software 50 can provide for entry of the dimension and angles in predefined increments (e.g., 0.1, 0.2, or 0.5 mm, or 1.0, 2.0, or 5.0 degrees). In other embodiments, other input features are screen-displayed for inputting the few topcap design parameters, for example data input fields for entering the individual dimensions/angles, or a menu of predefined dimensions or ranges can be provided to select from (e.g., “narrow,” “medium,” and “wide” that correspond to predetermined shoulder width ranges, and/or “short,” “medium,” and “tall” that correspond to predetermined topcap height ranges).

The shoulder width is selected to provide sufficient thickness for a crown to seat atop the abutment, the overall height is selected based on the patient's oral anatomy, and the buccal-lingual and mesial-distal angles are selected to provide the desired tilt based on the patient's oral anatomy. Thus, the shoulder width effectively defines and can be considered a selection of the topcap width, and this can be selected based on the prosthetic to be used. The emergence height was input in a previous step based on the pocket margin depth/width measurements, and so effectively the current step can be considered to be selecting the topcap height (the difference between the overall height desired and the emergence height on each side of the abutment), but the software can provide for setting the height dimension as described herein for ease of selecting a single input. Also, the overall height selection can be based (at least in part) on an additional manual measurement taken by the clinician (e.g., at step 12) of the height of the adjacent teeth and/or the width of the inter-occlusal space, and not just a visual estimation. Furthermore, the topcap tilt angles can be selected based (at least in part) on additional manual measurements taken by the clinician (e.g., at step 12) of the axial orientation of the implant 36, and not just a visual estimation.

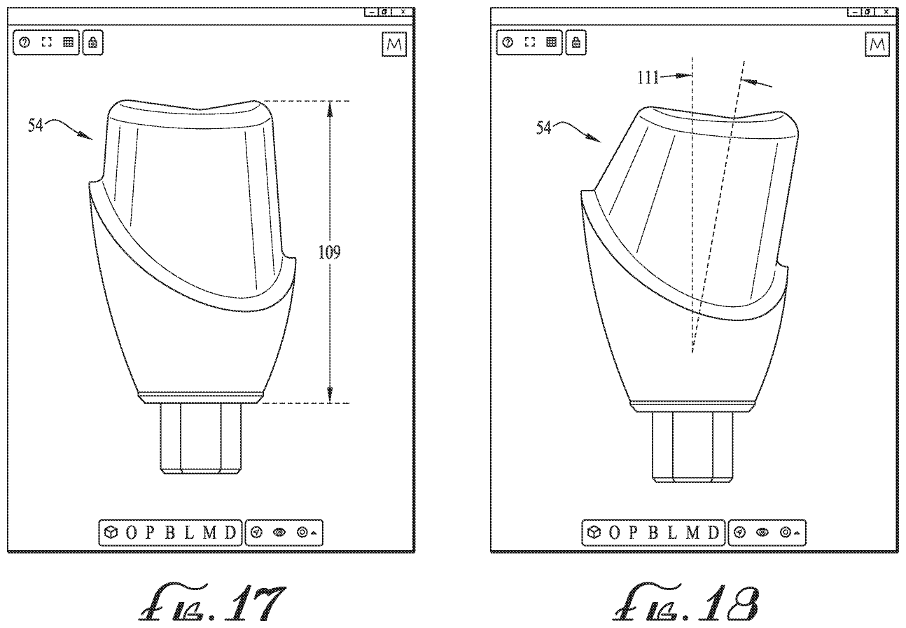

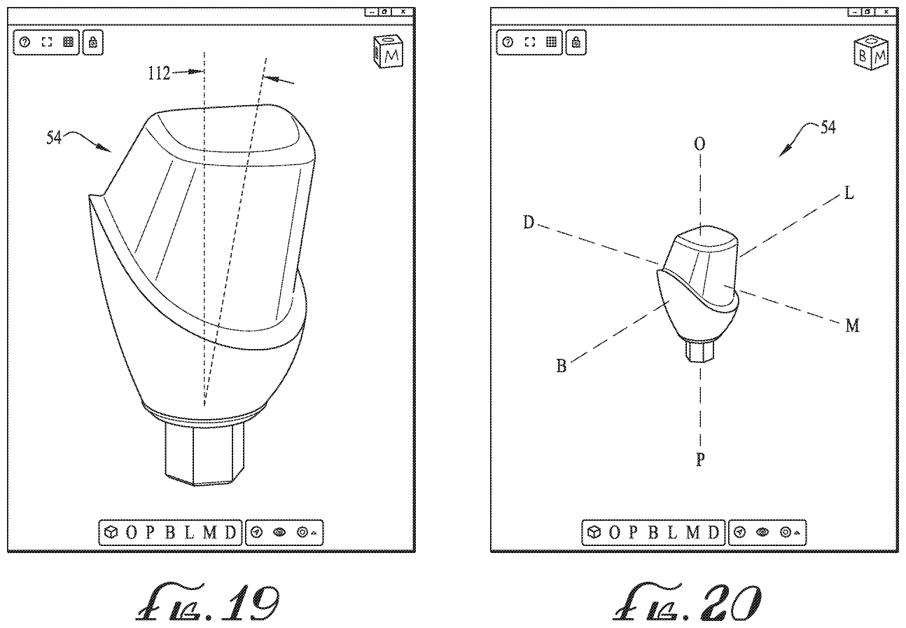

As depicted, a button 106 corresponding to a width of the topcap shoulder can be adjusted (for example, to 0.5 mm, see FIG. 16, left window) to produce a customization of the digital abutment 54 displayed by correspondingly adjusting the topcap shoulder width 107 (see FIG. 16, right window). Similarly, a button 108 corresponding to a height of the overall abutment can be adjusted (for example, to 11.0 mm, see FIG. 16, left window) to produce a customization of the digital abutment 54 displayed by correspondingly adjusting the overall height 109 (see FIG. 17). Also, a button 108 corresponding to a topcap angle in the buccal-lingual plane can be adjusted (for example, to 10.0 degrees, see FIG. 16, left window) to produce a customization of the digital abutment 54 displayed by correspondingly adjusting the topcap buccal-lingual angle 111 (see FIG. 18). Similarly, a button 110 corresponding to a topcap angle in the mesial-distal plane can be adjusted (for example, to 10.0 degrees, see FIG. 16, left window) to produce a customization of the digital abutment 54 displayed by correspondingly adjusting the topcap mesial-distal angle 113 (see FIG. 19).

The virtual abutment 54 has now been semi-customized sufficiently to provide good fit and comfort for the patient, based only on taking a few measurements and inputting them into the software 50, then making a few component-type selections and a few component-parameter adjustments using the software 50. While not producing the precise and optimized fit of more-complex and difficult-to-use abutment design software systems, this “good-enough” fit is achieved by easy-to-use semi-customizing design software and steps that can be used by many more dental professionals.

More particularly, this software-implemented design method includes semi-custom designing the digital abutment by inputting discrete/incremented values (measurements) to produce a visual screen-displayed digital model of the abutment design providing a close-enough approximation of an optimized abutment design, and does not provide “handles” on the displayed model that permit toggling to adjust the surface in any direction to any position to manipulate the model to produce unique shapes and/or other features customized/optimized for patient-specific anatomy. Additionally, the only visual aids displayed by the software are gross anatomic directions—the software does not store or display any geometry of neighboring or patient-specific anatomy to help in the abutment design process. So the operator can only design the abutment based off of desired dimensions and angles measured (directly or indirectly) from the patient's oral anatomy, because the software provides no visual correspondence to their oral anatomy.

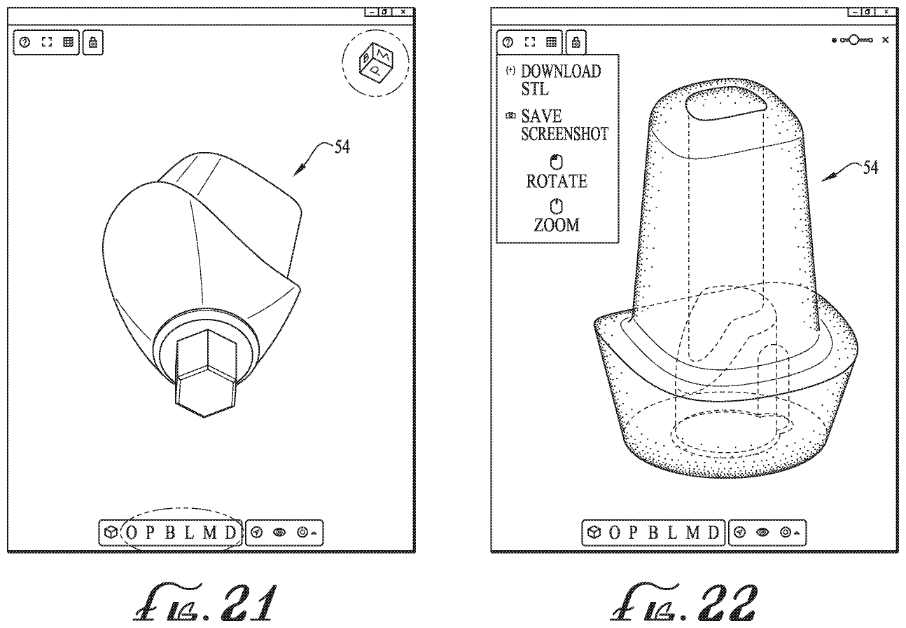

In step 18 of the method 10, the software in some embodiments can provide options for visualization of the semi-customized abutment 54. For example, this step can be initiated by clicking on a respective button (e.g., the “confirm” button of FIG. 16, left window), which causes a screen-display of the virtual abutment 54 along with a six-axis coordinate system for the abutment, as shown for example in FIG. 20. The six axes are buccal (B), lingual (L), mesial (M), distal (D), occlusal (0), and platform (P). This enables the user to conduct a visual “sanity check” of the final design, as any significant errors in the data entry should result in obvious defects in the virtual abutment 54 displayed, which can be a useful step because the digital abutment 54 is designed without a displayed relationship to neighboring oral anatomy. That is, the digital abutment 54 is designed based only on user-selected bottom portion/emergence and top portion/topcap base shapes and a few user-entered discrete values (dimensions and angles) based on manual measurements and visual estimations (via clinician expertise), with no neighboring oral anatomy displayed (with the displayed digital abutment 54) to aid in the design process.

In various embodiments, as shown for example in FIGS. 20-21, the software 50 can screen-display all six axes with their respective labels (as depicted), a menu of the labels (e.g., across the bottom of the screen), a cube with each side corresponding to the respective axis (e.g., in the upper right corner), or another combination of these and/or other functionally-equivalent features. As the design is based off of measurements taken with respect to common anatomical directional references, the software 50 displays a corresponding set of coordinate axes, and the corresponding buttons across the bottom enable the user to click on them to “snap to” the respective view, with the cube in the top right corner displaying the relative orientation as the user toggles and thus manually moves the abutment design 54 around in 3D space. For example, with the abutment 54 in the orientation shown in FIG. 20, clicking on the “P” axis label/identifier reorients the abutment 54 to that shown in FIG. 21, with the orientation cube (e.g., top right corner) reorienting to match.

In some embodiments such as that depicted, additional toggle icons/buttons are provided (e.g., to the right of the axes menu across the bottom of the screen). These can include an icon (e.g., compass-looking) for toggling between orientation labels (e.g., identifiers/letters) that provide visual indicators to further clarify directions/surfaces. These can also include an icon (e.g., an eye/slash mark) for toggling between transparent and solid design representations, for example to reveal the presence of the titanium base within hybrid zirconia restorations. And these can further include an icon (e.g., a bullseye) for toggling between displays of the outer limit, the inner limit, and the screw channel. The outer and inner limit can be approximated by cylinders that roughly define the maximum and minimum design constraints (manufacturability or structural considerations, e.g., not manufacturable, too large/cantilevered for safe use clinically, and/or too thin-walled) associated with the abutment. The screw channel gives consideration for the size and location of the thru-hole to be included in the final abutment design for receiving the mounting screw.

Finally, in some embodiments such as that depicted, the visualization screen can display additional view toggles, such as those at the top left of FIG. 20. These can include an icon (e.g., a lock) for enabling and disabling “camera snapping,” a feature where upon an edit of a B-L, M-D, or other anatomic-direction-specific design constraint, the camera automatically switches to that direction. These can also include an icon (e.g., mesh-looking) for enabling and disabling a wireframe view of the abutment design, as some users may prefer this visual to the smooth one. Coincidentally, this closely approximates the form of vertices that the final digital design file (e.g., STL) will represent. These can further include an icon (e.g., corner-frame) for enabling and disabling full screen view of the abutment design simulation. Finally, these can include an icon (e.g., a question mark) that's not really a toggle, but rather a functional menu. Clicking on this icon presents the user with options to save a screenshot for later reference (a PNG or other image file), download the current design file (e.g., STL), and provide a reminder of the mouse buttons that govern movement/exploration of the design preview.

It should be noted that, while the example semi-custom abutment design software 50 shown and described herein provides design options for a single implant manufacturer and its particular implant geometries, various other related embodiments are contemplated by and included in the scope of the present invention. For example, the semi-custom abutment design software can be provided with design options for a number of different implant manufacturers and their particular implant geometries, provided in an “open to developers” version where additional implant manufacturers can add their implant geometries, or provided in other versions and formats as may be desired and are within the capabilities of persons of ordinary skill in the art.

With particular reference to FIG. 22, in step 20 of the method 10, the confirm process can include the software 50 functioning to display a summary including the metrics input (for use in referring back to original defining measurements) as well as 2D snapshot images of the abutment design 54. Upon confirming the digital abutment design 54 is complete and correct, the software 50 provides for generating a CAM-usable file of the digital abutment design 54 that can be used in a CAM process (e.g., 3D printing, CNC milling, wax and cast, hybrid print/mil, other additive manufacturing, other subtractive manufacturing, other combination additive/subtractive manufacturing, or other computer-aided digital manufacturing processes for producing 3D models) to manufacture the corresponding physical abutment. In typical embodiments, the CAM file is an STL file for use with CAM equipment (e.g., the depicted wireframe model), though alternatively the software can generate another CAM file type such as an OBJ, PLY, 3MF, or AMF file, or another 3D model file format that encodes surface geometry. For a digital abutment design having a titanium base, the generated or downloaded STL (or other CAM-compatible) file matches that designed and displayed by the software 50, except with the interfacing geometry to mate with the titanium base now subtracted and appended appropriately.

In some embodiments, the software 50 generates the STL (or other CAM) file by combining predefined meshes of inalterable areas (e.g., implant connections) with the semi-customized mesh for the alterable regions (e.g., pocket margin heights, shoulder widths). In some embodiments, abutment geometry that is common to many patients can be pre-generated, so once the abutment design is set based on the inputted discrete measurements and type selections, the corresponding abutment design is pulled and immediately available, and in other embodiments all of the abutment geometry can be generated as the design inputs are received. In some embodiments, common abutment designs (or features thereof) are saved for future use, or they can be passed along to a milling center for manufacturing standardized abutments that are commonly ordered. And in some embodiments, the STL (or other CAM) file is generated and downloadable for the user, but then not stored permanently, with the user responsible for self-storage of custom-generated files.

At this point the software 50 enables the user to send an order for fulfillment of the physical abutment 30. This can be done for example by outputting and sending the CAM file to a CAM manufacturer (e.g., a milling center) for fabrication, by providing the fabricator with access to the software for downloading directing, by generating a code that lists the inputted selections and data/measurements and sending the code to the fabricator for it to create the STL file, or by sending the order to another type of fulfillment facility (e.g., a warehouse storing an inventory of CAM-made abutments of commonly used/ordered designs that have been premade and stored until ordered).

In step 22 of the method 10, the CAM file is received by the CAM-equipped fabricator. And in step 24, the physical abutment 30 is manufactured using the CAM equipment based on the CAM file of the digital abutment design 54. The CAM software/equipment (e.g., example types described above) can be of a conventional type that is well-known in the art, so details are understood by persons of ordinary skill in the art and are thus excluded for brevity. As noted above, commonly used/ordered abutment designs can be manufactured and inventoried in advance, and in such cases the physical abutment has already been CAM-fabricated and is in this step merely identified as such and located in the storehouse. For such embodiments, a prior directory (e.g., a database) of common designs can be provided and the design software 50 can run a routine to identify if the newly designed abutment matches one of the common-design abutments.

Finally, in step 26 of the method 10, the physical abutment 30 is received from the CAM fabricator (or other fulfillment facility) and the dental clinician delivers it to the patient. FIG. 23 shows the physical semi-custom abutment 30 mounted in place (to and over the underlying implant) in the patient's mouth 34, now ready for the prosthesis to be mounted to it.

The abutment design software 50 and the overall dental restoration method 10 thereby provide advantages over the prior art. For example, in example embodiments of the semi-custom design software, the user does not work off of a model input into the software by way of a 3D scan. Instead, the user inputs a discrete number of relatively crude manual measurements (dimensions and angles) and abutment-type selections to determine the basic/essential size of the abutment desired, then inputs those measurements into the software where it is adapted into a visual model and displayed. This is in contrast to conventional customizing/optimizing software and methods, in which the patient (or a model) is scanned, the scan file is input into the CAD software, which is used to locate the implant via an alignment algorithm, and which is then used by manually dragging toggles on the displayed abutment to manipulate it to bring it into a unique size and shape configuration, with a virtually infinite possibility of configuration available for optimizing the abutment. While this may seem somewhat primitive, it has a distinct advantage: the user does not need to have a 3D scanner, expensive dental CAD design software, or a high-end computer to effectively create a functional abutment that can be manufactured using CAD/CAM technology. And while a traditional/non-techy lab can typically cast a custom abutment out of a material like gold/palladium alloys, it is now desirable to make abutments of modern ceramics, titanium, and/or cobalt chrome, which are not so easily processed. Instead, CAM is required to manufacture them, and thus CAD becomes the limiting factor in producing abutments of those materials. The semi-custom abutment design software 50 thereby significantly lowers the barrier to CAD entry.

The semi-custom abutment design software 50 can be downloaded, web-based, stored on a non-transitory storage device (e.g., magnetic and/or optical drive), or provided in other conventional formats. Also, the semi-custom abutment design software 50 can be located remotely and independently in a workflow where the user simply submits measurements on paper for a third-party operation to input into the software (e.g., non-digital users who prefer paper-based prescriptions), provided online where the design feeds an order directly to a milling center, and/or provided in a version where the output (whether online or locally installed) outputs the CAM file to manufacturer. Additionally or as a supplement, the software 50 can be hosted on a website and/or provided as a standalone application (e.g., mobile-optimized) that the user can download and then locally run (without internet access).

As such, the semi-custom abutment design software 50 includes instruction sets (e.g., programmable by coders of ordinary skill in the art) that can be stored on a computer-readable medium of a conventional type (i.e., a non-transitory storage device) and that can be read by a conventional computer processor to implement the functionality described and shown herein. The design software 50 can thus be stored locally on a server or a bank of servers and locally accessed by users via a client/server network (e.g., a LAN), or it can be stored remotely on a server or a bank of servers (e.g., in the cloud or another distributed network) and remotely accessed by users via a large-scale communications network (e.g., the internet or a cellular network). The users (also referred to herein as dental professionals, clinicians, and operators) can thus access and use the design software 50 on conventional connected computer devices (e.g., desktops, laptops, tablets, and smartphones; the software can be optimized for particular uses as may be desired), and as such the design software 50 includes a GUI for interfacing with the screen displays and other input and/or output devices of the connected computer devices (the drawing figures depict representative screen displays provided by the GUI). Also, in some embodiments the design software 50 provides for all outputs (e.g., design/option selections and displayed models) and inputs (measurement data entries) to be via touch-screens of the connected computer devices.

While the invention has been described with reference to example embodiments, it will be understood by those skilled in the art that a variety of modifications, additions, and deletions are within the scope of the invention, as defined by the following claims.

What is claimed is:

1. A method of designing a semi-custom dental abutment for a patient, comprising:
displaying one or more interface features that correspond to teeth options of a dental arch;
receiving a user-input selection of one of the teeth options of the dental arch;
displaying a base abutment model that corresponds to the selected tooth option;
displaying one or more interface features that correspond to one or more dimensional options for an emergence of the selected base abutment model and one or more interface features that correspond to one or more dimensional options of a topcap of the updated abutment model;
receiving one or more user-input values for the dimensional options of the emergence of the selected base abutment model and one or more user-input values for the dimensional options of the topcap of the updated abutment model;
displaying an updated abutment model with the emergence having an updated geometry based the user-input emergence values and with the topcap having an updated geometry based the user-input topcap values; and
outputting a digital file of a final design of the abutment model, which includes the updates of the preceding steps, for CAM fabrication of the semi-custom abutment.

2. The abutment semi-custom design method of claim 1, wherein the user-input values for the dimensional options of the emergence and the topcap are obtained by manual measurements of the patient's oral geometry including measurements relative to an existing implant that the abutment is to be designed to connect to.

3. The abutment semi-custom design method of claim 2, wherein the manual measurements are obtained by using a dental tool, by visual estimation, or by a combination thereof.

4. The abutment semi-custom design method of claim 1, wherein the interface features for designing the emergence and the topcap provide for receiving only a limited number of possible user-input values for each of the dimensional options for the emergence and the topcap.

5. The abutment semi-custom design method of claim 4, wherein the abutment is semi-custom designed based on the user-input values for the dimensional options of the emergence and the topcap, without receiving a 3D scan model of the patient's oral geometry including an existing implant, without displaying the 3D model, and without displaying toggles or handles that a user can drag to manipulate the 3D model into any desired optimized size and shape.

6. The abutment semi-custom design method of claim 1, wherein the emergence-designing interface features provide for receiving the user-input values for the emergence which include one or more user-input widths of a pocket margin surrounding the patient's existing implant that the abutment is to connect to, and wherein the updated abutment model is displayed with the emergence having an updated width based the user-input pocket margin width values.

7. The abutment semi-custom design method of claim 1, wherein the emergence-designing interface features provide for receiving the user-input values for the emergence which include one or more user-input depths of a pocket margin surrounding the patient's existing implant that the abutment is to connect to, and wherein the updated abutment model is displayed with the emergence having an updated height based the user-input pocket margin depth values.

8. The abutment semi-custom design method of claim 1, wherein the topcap-designing interface features provide for receiving the user-input values for the topcap which include one or more user-input shoulder widths of the topcap that a prosthetic crown is to connect to, and wherein the updated abutment model is displayed with the topcap having an updated shoulder width based the user-input topcap shoulder width values.

9. The abutment semi-custom design method of claim 1, wherein the topcap-designing interface features provide for receiving the user-input values for the topcap which include one or more user-input heights of the topcap that a prosthetic crown is to connect to, and wherein the updated abutment model is displayed with the topcap having an updated height based the user-input topcap height values.

10. The abutment semi-custom design method of claim 1, wherein the topcap-designing interface features provide for receiving the user-input values for the topcap which include one or more user-input tilt angles of the topcap that a prosthetic crown is to connect to, and wherein the updated abutment model is displayed with the topcap having an updated tilt angle based the user-input topcap tilt angle values.

11. The abutment semi-custom design method of claim 1, further comprising:
displaying one or more additional interface features that correspond to one or more additional options for the emergence or the topcap, receiving one or more additional user-input selections for the additional options for the emergence or the topcap, and displaying a further updated abutment model with the emergence and the topcap updated based on the additional user-input selections,
wherein the additional user-input selections include a shape of the emergence selected from a limited number of predefined options, a material of the emergence selected from a limited number of predefined options, a timing angle for the rotational orientation of the abutment, an abutment connection size for matingly mounting to an existing implant, a screw channel angle for aligned mounting to an existing implant, or a combination thereof.

12. The abutment semi-custom design method of claim 1, further comprising generating a CAM-usable digital file of the final design of the abutment model, wherein the file-outputting step includes sending the CAM-usable file to a fulfillment facility for obtaining the CAM-fabricated abutment.

13. A non-transitory storage device storing an instruction set for preforming the abutment semi-custom design method of claim 1.

14. A dental restoration method using the semi-custom abutment design method of claim 1, comprising:
obtaining manual measurements of the patient's oral geometry including measurements relative to an existing implant that the abutment is to connect to;
designing the final model of the semi-custom abutment according to the method of claim 1;
obtaining the semi-custom abutment based on the final design and made using CAM-equipment; and
implanting the CAM-fabricated semi-custom abutment into place in the patient's mouth.

15. A method of designing a semi-custom dental abutment for a patient, comprising:
displaying one or more interface features that correspond to teeth options of a dental arch;
receiving a user-input selection of one of the teeth options of the dental arch;
displaying a base abutment model that corresponds to the selected tooth option;
displaying one or more interface features that correspond to one or more dimensional options for an emergence of the selected base abutment model and one or more interface features that correspond to one or more dimensional options of a topcap of the updated abutment model;
receiving one or more user-input values for the dimensional options of the emergence of the selected base abutment model and one or more user-input values for the dimensional options of the topcap of the updated abutment model;
displaying an updated abutment model with the emergence having an updated geometry based the user-input emergence values and with the topcap having an updated geometry based the user-input topcap values;
generating a CAM-usable digital file of the final design of the abutment model, which includes the updates of the preceding steps, for CAM fabrication of the semi-custom abutment; and
outputting the CAM-usable file for sending to a fulfillment facility for obtaining the CAM-fabricated abutment,
wherein the emergence-designing interface features provide for receiving the user-input values for the emergence which include one or more user-input widths and depths of a pocket margin surrounding an existing implant that the abutment is to connect to, and wherein the updated abutment model is displayed with the emergence having an updated width and height based the user-input pocket margin width and depth values, and
wherein the topcap-designing interface features provide for receiving the user-input values for the topcap which include one or more user-input heights and shoulder widths of the topcap that a prosthetic crown is to connect to, and wherein the updated abutment model is displayed with the topcap having an updated height and shoulder width based the user-input topcap height and shoulder width values.

16. The abutment semi-custom design method of claim 15, wherein the user-input values for the dimensional options of the emergence and the topcap are obtained by manual measurements of the patient's oral geometry including measurements relative to an existing implant that the abutment is to be designed to connect to, wherein the manual measurements are obtained by using a dental tool, by visual estimation, or by a combination thereof.

17. The abutment semi-custom design method of claim 15, wherein the interface features for designing the emergence and the topcap provide for receiving only a limited number of possible user-input values for each of the dimensional options for the emergence and the topcap, and wherein the abutment is semi-custom designed based on the user-input values for the dimensional options of the emergence and the topcap, without receiving a 3D scan model of the patient's oral geometry including an existing implant, without displaying the 3D model, and without displaying toggles or handles that a user can drag to manipulate the 3D model into any desired optimized size and shape.

18. The abutment semi-custom design method of claim 15, further comprising:
displaying one or more additional interface features that correspond to one or more additional options for the emergence or the topcap, receiving one or more additional user-input selections for the additional options for the emergence or the topcap, and displaying a further updated abutment model with the emergence and the topcap updated based on the additional user-input selections,
wherein the additional user-input selections include a shape of the emergence selected from a limited number of predefined options, a material of the emergence selected from a limited number of predefined options, a timing angle for the rotational orientation of the abutment, an abutment connection size for matingly mounting to an existing implant, a screw channel angle for aligned mounting to an existing implant, one or more tilt angles of the topcap, or a combination thereof.

19. A non-transitory storage device storing an instruction set for preforming the abutment semi-custom design method of claim 15.

20. A dental restoration method using the semi-custom abutment design method of claim 15, comprising:
obtaining manual measurements of the patient's oral geometry including measurements relative to an existing implant that the abutment is to connect to;
designing the final model of the semi-custom abutment according to the method of claim 1;
obtaining the semi-custom abutment based on the final design and made using CAM-equipment; and
implanting the CAM-fabricated semi-custom abutment into the patient's mouth.
